(19) United States
(12) Patent Application Publication
(10) Pub. No.: US 2008/0233442 A1
(43) Pub. Date: Sep. 25, 2008

(54) Starting Method of Fuel Cell and Fuel Cell System

(75) Inventor: Kazumasa Takada, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/995,203

(22) PCT Filed: Jan. 29, 2007
(86) PCT No.: PCT/JP07/51409

§ 371 Date: Jan. 10, 2008

(30) Foreign Application Priority Data
Jan. 30, 2006 (JP) 2006 021283

(51) Int. Cl. H01M 8/06

(52) U.S. Cl. 429/20; 429/17

(57) ABSTRACT

The invention provides a fuel cell starting method and a fuel cell system capable of making an operation starting stable.

The fuel cell starting method and the fuel cell system are provided with a reformer 10, a burner 20 and a fuel cell 30 and having step S4 of igniting the burner 20 with combustion fuel and combustion air being supplied thereto and steps S5 to S12 of leading at least a part of generation gas sent from the reformer 10 to the burner 20 while supplying combustion fuel and combustion air to the burner 20. The steps S5 to S12 include steps S8 to S12 for the case that the temperature of the burner before ignition is equal to or lower than 100° C. and steps S7, S9 to S12 of supplying the combustion fuel and the combustion air to make the air ratio smaller than that at the steps S8 to S12 in the case that the temperature of the burner 20 before ignition is higher than 100° C.

### TECHNOLOGICAL FIELD

The present invention relates to a fuel cell starting method and a fuel cell system utilizing the starting method.

### BACKGROUND ART

A fuel cell generates electric power through a chemical reaction of hydrogen-containing fuel gas and oxidizer gas which are supplied respectively to a fuel pole and an oxidizer pole thereof. The fuel gas can be obtained by reforming fuel by the use of reforming catalyzer, wherein the temperature of the reforming catalyzer should be kept at a high temperature in order to obtain the fuel gas stably. To this end, at the time of a starting operation of the fuel cell, a burner is supplied with combustion fuel and combustion air to heat a reformer, and at the time of an ordinary operation in which the fuel cell generates electric power, the burner is supplied with anode offgas (i.e., hydrogen-containing reforming gas having been not consumed at the fuel pole) exhausted from the fuel cell and with combustion air to heat the reformer. In order to bring the fuel cell into the ordinary operation as fast as possible, it is necessary to shorten a starting operation time for the fuel cell and to start the fuel cell stably.

Heretofore, as a fuel cell starting method and a fuel cell system, there have been known those described in Patent Document 1 and Patent Document 2. The fuel cell starting method and the fuel cell system described in Patent Document 1 is of the configuration that at a first operation stage, a burner is ignited with combustion fuel and combustion air being supplied thereto and that at a second operation stage, the combustion fuel supplied to the burner is decreased gradually while reforming fuel supplied to a reformer is increased gradually to lead generation gas fed from the reformer to the burner. In the fuel cell starting method and the fuel cell system, since the generation gas fed from the reformer can be used as combustion fuel, it can be realized to shorten the starting operation time for the fuel cell.

Further, the fuel cell starting method and the fuel cell system described in Patent Document 2 is of the configuration that at a first operation stage, a burner is ignited with combustion fuel and combustion air being supplied thereto and that at a second operation stage, the supply of reforming water is increased to a predetermined flow rate as the temperature of reforming catalyzer in a reformer is increased. In the fuel cell starting method and the fuel cell system, since nonuniformity in temperature is unlikely to occur over the reforming catalyzer and since the fuel gas is easy to become stable in quality, it can be realized to shorten the starting operation time for the fuel cell.

Patent Document 1: Japanese unexamined, published patent application No. 2001-354401 (pages 3-4 and FIG. 1)
Patent Document 2: Japanese unexamined, published patent application No. 2004-146089 (pages 6-8 and FIGS. 3-4)

### DISCLOSURE OF THE INVENTION

### Problem to be Solved by the Invention

However, in the fuel cell starting methods and the fuel cell systems of the aforementioned prior art, it may occur that the fuel cell system cannot be started stably because its state prior to the starting is not taken into consideration. That is, in these fuel cell starting methods and these fuel cell systems, where the fuel cell is restarted (hot starting) right after being stopped, a large volume of steam is generated right after the supply of reforming water to the reformer because the same remaining at a high temperature. When returning to the burner, the steam can be a cause to extinguish the burner. Further, in these fuel cell starting methods and these fuel cell systems, the same sequence is used whether an ordinary starting (cold starting) or a restarting right after a stop (hot starting) of the fuel cell. This makes narrow the range of a tolerable air ratio for keeping the combustion, so that fuel cell starting methods and the fuel cell systems are low in robustness.

The present invention has been made taking the problems of the foregoing prior art into consideration, and an object thereof is to provide a fuel cell starting method and a fuel cell system which are capable of being started stably.

### Measures for Solving the Problem

In order to solve the aforementioned problems, the feature of a fuel cell starting method according to claim 1 resides in that in a fuel cell starting method provided with a reformer for generating fuel gas containing hydrogen from reforming fuel and reforming water, a burner for heating the reformer and a fuel cell for generating electric power from the fuel gas and oxidizer gas, and including a first operation stage of igniting the burner with combustion fuel and combustion air being supplied thereto and a second operation stage of continuously supplying the combustion fuel and the combustion air to the burner and of supplying the reforming water to the reformer wherein at the second operation stage, gas led from the reformer is led to the burner, the second operation stage includes a cold starting routine for the case that the temperature of the burner before ignition is equal to or lower than a predetermined temperature, and a hot starting routine for supplying the combustion fuel and the combustion air to make the air ratio in the hot starting routine smaller than that in the cold starting routine in the case that the temperature of the burner before ignition is higher than the predetermined temperature.

The feature of the fuel cell starting method according to claim 2 resides in that in claim 1, the supply of the combustion fuel is decreased in the cold starting routine than that at the first operation stage while the supply of the combustion air is increased in the cold starting routine than that at the first operation stage.

The feature of the fuel cell starting method according to claim 3 resides in that in claim 1 or 2, the reformer is supplied with the reforming water at the second operation stage without being supplied with the reforming fuel.

The feature of the fuel cell starting method according to claim 4 resides in that in any one of claims 1 to 3, the supply of the combustion fuel in the hot starting routing is held at a predetermined flow rate.

The feature of a fuel cell system according to claim 5 resides in that in a fuel cell system comprising a reformer for generating fuel gas containing hydrogen from reforming fuel and reforming water, a burner for heating the reformer, a fuel cell for generating electric power from the fuel gas and oxidizer gas, and control means having a first operation stage of igniting the burner with combustion fuel and combustion air being supplied thereto and a second operation stage of continuously supplying the combustion fuel and the combustion air to the burner and of supplying the reforming water to the reformer for leading gas led from the reformer to the burner at the second operation stage, the control means executes at the second operation stage a cold starting routine in the case that the temperature of the burner before ignition is equal to or lower than a predetermined temperature, and a hot starting routine for supplying the combustion fuel and the combustion air to make the air ratio in the hot starting routine smaller than that in the cold starting routine in the case that the temperature of the burner before ignition is higher than the predetermined temperature.

The feature of the fuel cell system according to claim 6 resides in that in claim 5, the supply of the combustion fuel is decreased in the cold starting routine than that at the first operation stage while the supply of the combustion air is increased in the cold starting routine than that at the first operation stage.

The feature of the fuel cell system according to claim 7 resides in that in claim 5 or 6, the reformer is supplied at the second operation stage with the reforming water without being supplied with the reforming fuel.

The feature of the fuel cell system according to claim 8 resides in that in any one of claims 5 to 7, the supply of the combustion fuel in the hot starting routine is held at a predetermined flow rate.

### EFFECTS OF THE INVENTION

In the fuel cell starting method according to claim 1, after the burner is ignited with combustion fuel and combustion air being supplied thereto at the first operation stage, the ratio in supply between combustion fuel and combustion air is changed at the second operation stage in dependence on the temperature of the burner prior to the ignition. That is, where the temperature of the burner prior to the ignition is higher than the predetermined temperature, combustion fuel and combustion air are supplied in the hot starting routine to make the air ratio smaller than that in the cold starting routine. Thus, where the fuel cell is restarted right after being stopped, sufficient combustion fuel has been supplied in the hot starting routine, and thus, the burner is hardly extinguished even if the reforming water is fed in the form of steam from the reformer to be returned to the burner. Further, because of the use of different sequences in the cold starting routine and the hot starting routine, it is possible to make wide the range of a tolerable air ratio for keeping the combustion. Accordingly, it is possible in the fuel cell starting method to start the fuel cell stably.

In the fuel cell starting method according to claim 2, where the temperature of the burner prior to ignition is equal to or lower than the predetermined temperature, combustion air sufficient for combustion fuel to burn is supplied in the cold starting routine in order to decrease the supply of combustion fuel and increase the supply of combustion air. Thus, it can be realized to reduce CO and NOx in combustion exhaust gas.

In the fuel cell starting method according to claim 3, since at the second operation stage, the reformer is supplied with reforming water without being supplied with reforming fuel, it can be realized to prevent carbon from adhering to the catalyzer in the reformer.

In the fuel cell starting method according to claim 4, since the supply of combustion fuel in the hot starting routine is held at the predetermined flow rate, combustion fuel can be supplied sufficiently to prevent the burner from being extinguished.

In the fuel cell system according to claim 5, after the burner is ignited with combustion fuel and combustion air being supplied thereto at the first operation stage, the ratio in supply between combustion fuel and combustion air is changed at the second operation stage in dependence on the temperature of the burner prior to the ignition. That is, where the temperature of the burner prior to the ignition is higher than the predetermined temperature, combustion fuel and combustion air are supplied in the hot starting routine to make the air ratio smaller than that in the cold starting routine. Thus, where the fuel cell is restarted right after being stopped, sufficient combustion fuel has been supplied in the hot starting routine, and thus, the burner is hardly extinguished even if the reforming water is fed in the form of steam from the reformer to be returned to the burner. Further, because of the use of the different sequences in the cold starting routine and the hot starting routine, it is possible to make wide the range of a tolerable air ratio for keeping the combustion. Accordingly, it is possible in the fuel cell system to start the fuel cell stably.

In the fuel cell system according to claim 6, where the temperature of the burner prior to ignition is equal to or lower than the predetermined temperature, combustion air sufficient for combustion fuel to burn is supplied in the cold starting routine in order to decrease the supply of combustion fuel and increase the supply of combustion air. Thus, it can be realized to reduce CO and NOx in combustion exhaust gas.

In the fuel cell system according to claim 7, since at the second operation stage, the reformer is supplied with reforming water without being supplied with reforming fuel, it can be realized to prevent carbon from adhering to the catalyzer in the reformer.

In the fuel cell system according to claim 8, since the supply of combustion fuel in the hot starting routine is held at the predetermined flow rate, combustion fuel can be supplied sufficiently to prevent the burner from being extinguished.

### BRIEF DESCRIPTION OF THE DRAWINGS

FIG. 1 relates to a fuel cell starting method and a fuel cell system in an embodiment and is a schematic view of the fuel cell system.

FIG. 2 relates to the fuel cell starting method and the fuel cell system in the embodiment and is a flow chart of a starting operation program.

FIG. 3 relates to the fuel cell starting method and the fuel cell system in the embodiment and is a time chart in the case of a starting operation being a hot starting.

FIG. 4 relates to the fuel cell starting method and the fuel cell system in the embodiment and is a time chart in the case of the starting operation being a cold starting.

### DESCRIPTION OF REFERENCE SYMBOLS

10 . . . reformer; 20 . . . burner; 30 . . . fuel cell; S4, S5 . . . first operation stage; S6 to S12 . . . second operation stage; S7, S9, S10, S11, S12 . . . hot starting routine; S8, S9, S10, S11, S12 . . . cold starting routine.

### Preferred Embodiment for Practicing the Invention

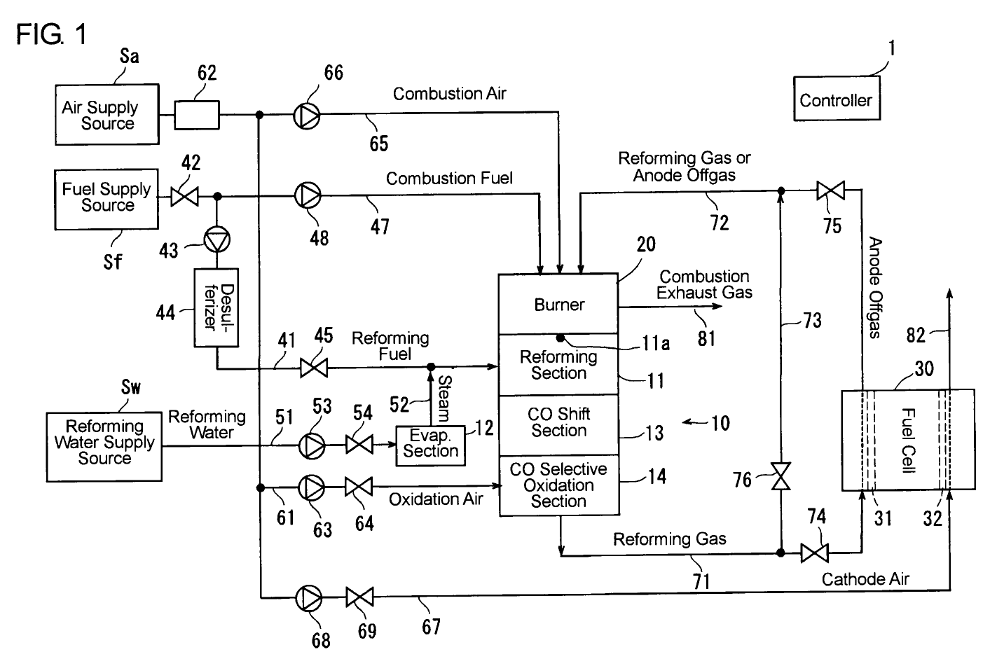

Hereafter, an embodiment concretizing a fuel cell starting method and a fuel cell system according to the present invention will be described with reference to the drawings. For the fuel cell starting method and the fuel cell system, there is used a fuel cell system shown in FIG. 1. The fuel cell system is provided with a reformer 10 for generating reforming gas containing hydrogen, as fuel gas, from reforming fuel and reforming water, a burner 20 for heating the reformer 10, a fuel cell 30 for generating electric power from the reforming gas and air as oxidizer gas, and a controller 1 for controlling the fuel cell system.

The reformer 10 is composed of a reforming section 11, an evaporator section 12, a carbon monoxide shift reaction section (hereafter referred to as “CO shift section”) 13, and a carbon monoxide selective oxidation section (hereafter referred to as “CO selective oxidation section”) 14.

The reforming section 11 generates reforming gas from a mixture gas of fuel and steam supplied from the outside and puts out the reforming gas. As the fuel, there may be employed natural gas, LPG, kerosene, gasoline, methanol or the like. The present embodiment will hereafter be described in the form using natural gas. The reforming section 11 is filled therein with catalyzer (e.g., Ru or Ni base catalyzer), and a mixture of reforming fuel led from a fuel supply pipe 41 with steam led from a steam supply pipe 52 reacts through the catalyzer and is reformed to generate hydrogen gas and carbon monoxide gas (a so-called steam reforming reaction). At the same time, a so-called carbon monoxide shift reaction takes place, in which the carbon monoxide, generated through the steam reforming reaction, and the steam react to be generated into hydrogen gas and carbon dioxide. These generated gases (so-called “reforming gas” collectively) are led to the CO shift section 13. The steam reforming reaction is an endothermic reaction, whereas the carbon monoxide shift reaction is an exothermic reaction. Further, the reforming section 11 is provided with a temperature sensor 11a on an inner surface of an inside wall on which combustion gas blown out from the burner 20 hits directly. By this temperature sensor 11a, it is possible to detect the burning temperature of the burner 20, that is, the inside wall temperature T of the reforming section 11. The detection result of the temperature sensor 11a is transmitted to the controller 1.

The reforming section 11 has connected thereto the fuel supply pipe 41 which is connected to a fuel supply source Sf (e.g., a city gas pipe), and is supplied with reforming fuel from the fuel supply source Sf. The fuel supply pipe 41 is provided thereon with a first fuel valve 42, a reforming fuel pump 43, a desulfurizer 44 and a second fuel valve 45 in order from the upstream side. The first and second fuel valves 42, 45 are responsive to commands from the controller 1 to open or close the fuel supply pipe 41. The reforming fuel pump 43 draws reforming fuel supplied from the fuel supply source Sf to discharge the reforming fuel to the reforming section 11 and is responsive to a command from the controller 1 to regulate the supply quantity of reforming fuel. The desulfurizer 44 removes sulfur ingredients (e.g., sulfur compounds) in the reforming fuel. Thus, the reforming fuel is supplied to the reforming section 11 after removal of the sulfur ingredients therefrom.

Further, a steam supply pipe 52 connected to the evaporator section 12 is connected to the fuel supply pipe 41 between the second fuel valve 45 and the reforming section 11. The steam supplied from the evaporator section 12 is mixed with the reforming fuel to be supplied to the reforming section 11. The evaporator section 12 is connected to a feedwater pipe 51 which is connected to a reforming water supply source Sw. The feedwater pipe 51 is provided thereon with a water pump 53 and a water valve 54 in order from the upstream side. The water pump 53 draws reforming water supplied from the reforming water supply source Sw to discharge the reforming water to the evaporator section 12 and is responsive to a command from the controller 1 to regulate the supply quantity of reforming water. The water valve 54 is responsive to a command from the controller 1 to open or close the feedwater pipe 51.

The evaporator section 12 generates steam by heating and boiling reforming water to supply the steam to the reforming section 11. The evaporator section 12 is connected to the feedwater pipe 51 as well as to the steam supply pipe 52, and water led from the feedwater pipe 51 is flown to pass through the evaporator section 12 and is heated to be discharged to the steam supply pipe 52 in the form of steam.

The CO shift section 13 serves to reduce the carbon monoxide in the reforming gas supplied from the reforming section 11, that is, serves as a carbon monoxide reduction section. The CO shift section 13 is filled with catalyzer (e.g., Cu—Zn base catalyzer), and the reforming gas led from the reforming section 11 is led through the catalyzer to be put out to the CO selective oxidation section 14. At this time, a so-called carbon monoxide shift reaction takes place, in which the carbon monoxide and the steam contained in the reforming gas being led react through the catalyzer to be generated into hydrogen gas and carbon dioxide gas. This carbon monoxide shift reaction is an exothermic reaction.

The CO selective oxidation section 14 serves to further reduce the carbon monoxide in the reforming gas supplied from the CO shift section 13 to supply the reforming gas to the fuel cell 30, that is, serves as a carbon monoxide reduction section. The CO selective oxidation section 14 is filled therein with catalyzer (e.g., Ru or Pt base catalyzer). Further, the CO selective oxidation section 14 is connected to a reforming gas supply pipe 71, and the reforming gas supplied from the CO shift section 13 is flown to pass through the CO selective oxidation section 14 and is discharged through the reforming gas supply pipe 71.

Further, oxidation air is mixed with the reforming gas supplied to the CO selective oxidation section 14. Specifically, the CO selective oxidation section 14 is connected to an oxidation air supply pipe 61 connected to the air supply source Sa and is supplied with oxidation air from the air supply source Sa (e.g., the atmosphere). The oxidation air supply pipe 61 is provided thereon with a filter 62, an air pump 63 and an air valve 64 in order from the upstream side. The filter 62 filtrates air. The air pump 63 draws air supplied from the air supply source Sa to discharge the air to the CO selective oxidation section 14 and is responsive to a command from the controller 1 to regulate the air supply quantity. The air valve 64 is responsive to a command from the controller 1 to open or close the oxidation air supply pipe 61. Thus, the oxidation air is mixed with the reforming gas from the CO shift section 13 to be supplied to the CO selective oxidation section 14.

Accordingly, the carbon monoxide in the reforming gas led to the CO selective oxidation section 14 reacts to oxygen in the oxidation air to become carbon dioxide. This reaction is an exothermic reaction and is expedited by the catalyzer. Thus, the reforming gas is further reduced (less than 10 ppm) in the density of carbon monoxide through the oxidation reaction and is supplied to a fuel pole 31 of the fuel cell 30.

The burner 20 is supplied with combustible gas (combustion fuel, reforming gas and anode offgas) and heats the reforming section 11 by burning the combustible gas. The combustion exhaust gas is exhausted through an exhaust pipe 81. The burner 20 is connected to a combustion fuel supply pipe 47 which is branched from the fuel supply pipe 41 on the upstream side of the reforming fuel pump 43, and is supplied with combustion fuel. The combustion fuel supply pipe 47 is provided with a combustion fuel pump 48 thereon. The combustion fuel pump 48 is a diaphragm-type pump and draws combustion fuel supplied from the fuel supply source Sf to discharge the combustion fuel to the burner 20. The combustion fuel pump 48 is responsive to a command from the controller 1 to regulate the supply quantity of combustion fuel.

Further, the burner 20 is connected to a combustion air supply pipe 65 which is branched from the oxidation air supply pipe 61 on the upstream side of the air pump 63 and is supplied with combustion air for burning combustion fuel, reforming gas or anode offgas. The combustion air supply pipe 65 is provided with a combustion air pump 66 thereon. The combustion air pump 66 draws combustion air supplied from the air supply source Sa to discharge the air to the burner 20 and is responsive to a command from the controller 1 to regulate the supply quantity of combustion air. When the burner 20 is ignited in response to a command from the controller 1, the combustion fuel, the reforming gas or the anode offgas supplied to the burner 20 is burned to generate combustion gas of a high temperature.

Cells each with a fuel pole 31 and an oxidizer pole 32 are piled up through a plurality of layers in the fuel cell 30. The fuel pole 31 of the fuel cell 30 is connected at its inlet port to the CO selective oxidation section 14 through the reforming gas supply pipe 71, and reforming gas is supplied to the fuel pole 31. The fuel pole 31 of the fuel cell 30 is connected at its outlet port to the burner 20 through an offgas supply pipe 72 to supply anode offgas discharged from the fuel cell 30 to the burner 20. A bypath pipe 73 bypasses the fuel cell 30 to make a direct connection between the reforming gas supply pipe 71 and the offgas supply pipe 72. The reforming gas supply pipe 71 is provided thereon with a first reforming gas valve 74 between a branched point to the bypath pipe 73 and the fuel cell 30. The offgas supply pipe 72 is provided thereon with an offgas valve 75 between a merging point with the bypath pipe 73 and the fuel cell 30. The bypath pipe 73 is provided with a second reforming gas valve 76. The first and second reforming gas valves 74, 76 and the offgas valve 75 are operable to open or close respective pipes and are controllable by the controller 1.

Further, the oxidizer pole 32 of the fuel cell 30 is connected at its inlet port to one end of a cathode air supply pipe 67 which is branched from the combustion air supply pipe 65 on the upstream side of the air pump 66, and cathode air as oxidizer gas is supplied into the oxidizer pole 32. The cathode air supply pipe 67 is provided thereon with a cathode air pump 68 and a cathode air valve 69 in order from the upstream side. The cathode air pump 68 draws cathode air supplied from the air supply source Sa to discharge the air to the oxidizer pole 32 of the fuel cell 30 and is responsive to a command from the controller 1 to regulate the supply quantity of cathode air. The cathode air valve 69 operates to open or close the cathode air supply pipe 67 in response to a command from the controller 1. Further, the oxidizer pole 32 of the fuel cell 30 is connected at its outlet port to one end of an exhaust pipe 82 which is opened to the atmosphere at its other end.

The controller 1 has electrically connected thereto the temperature sensor 11a, the respective pumps 43, 48, 53, 63, 66, 68, the respective valves 42, 45, 54, 64, 69, 74, 75, 76 and the burner 20. The fuel cell system is controllable by the controller 1.

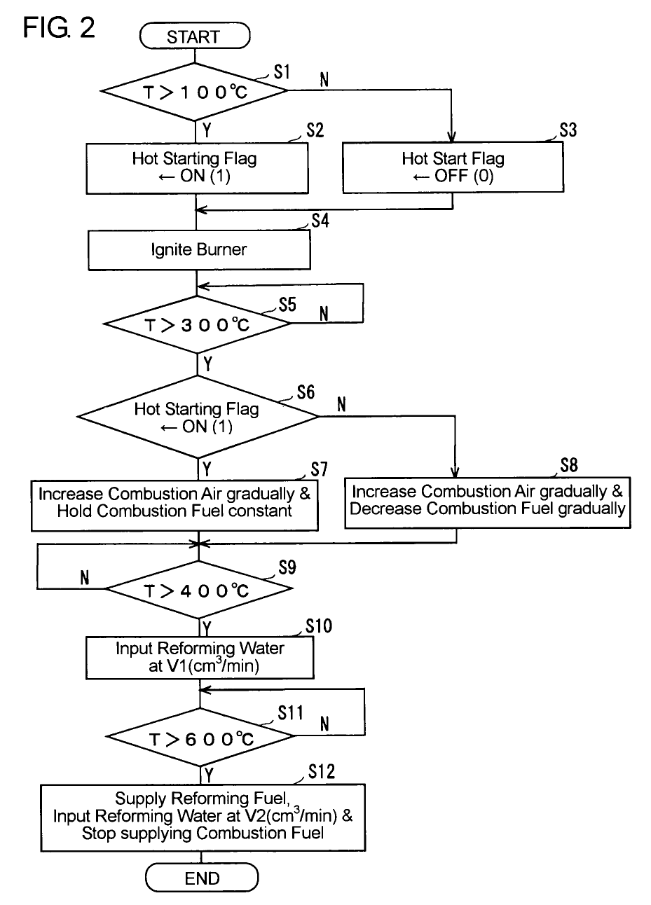

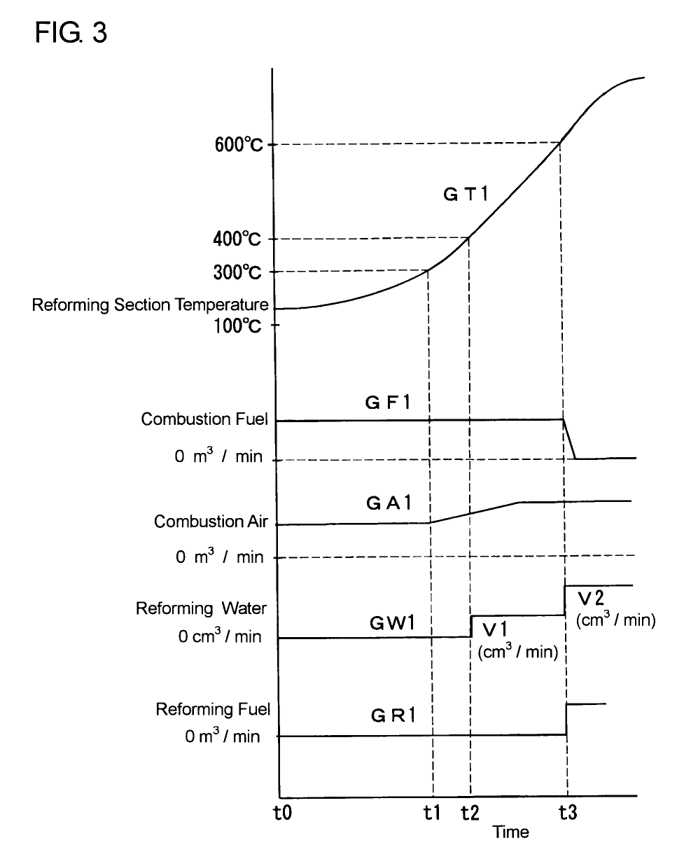

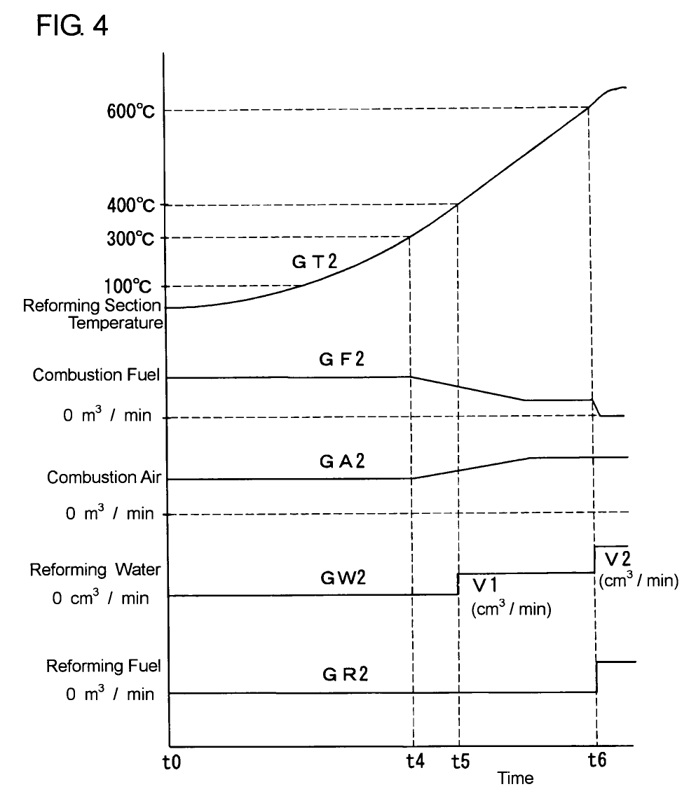

The operation of the fuel cell system as constructed above will be described with reference to FIGS. 2 to 4. FIG. 2 is a flow chart of a starting operation program. Further, FIG. 3 is a time chart showing the inner wall temperature T of the reforming section 11 and the supply quantities of combustion fuel, combustion air and reforming water in the case of the starting operation being a hot starting. Further, FIG. 4 is a time chart showing the inner wall temperature T of the reforming section 11 and the supply quantities of combustion fuel, combustion air and reforming water in the case of the starting operation being a cold starting. When a start switch (not shown) is turned on at time t0 shown in FIGS. 3 and 4, the controller 1 begins the execution of the starting operation program shown in FIG. 2.

At step S1, a check is made of whether the inner wall temperature T of the reforming section 11, that is, the temperature of the burner 20 before ignition which temperature is inputted from the temperature sensor 11a is higher than 100° C. or not. Where the inner wall temperature T of the reforming section 11 is higher than 100° C. (YES), the stating operation is judged as being a restarting right after the stopping of the fuel cell system, that is, as being a hot starting, and step S2 is then reached. Further, where the inner wall temperature T of the reforming section 11 is equal to or lower than 100° C. (NO), the stating operation is judged as being an ordinary starting of the fuel cell system, that is, as being a cold starting, and step S3 is then reached.

At step S2, a hot starting flag is set to ON (1) to memorize being a hot starting, and step S4 is then reached. At step S3, the hot starting flag is set to OFF (0) to memorize being a cold starting, and step S4 is then reached. At step S4, the burner 20 is ignited. Specifically, the combustion air pump 66 is driven to supply combustion air from the air supply source Sa through the combustion air supply pipe 65 to the burner 20. Further, the combustion fuel pump 48 is driven and the first fuel valve 42 is opened to supply combustion fuel from the fuel supply source Sf through the combustion fuel supply pipe 47 to the burner 20, which is then ignited. Further, the second reforming gas valve 76 is opened to make a direct connection between the reforming gas supply pipe 71 and the offgas supply pipe 72 through the bypath pipe 73. With the burner 20 being ignited, combustion gas is blown out from the burner 20 and causes the reforming section 11 to rise in temperature. The combustion gas is exhausted through the exhaust pipe 81. Then, at step S5, waiting is continued until the inner wall temperature T of the reforming section 11 rises over 300° C., and step S6 is reached when the temperature T rises over 300° C. Here, steps S4 and S5 constitute a first operation stage. This first operation stage covers the duration from time t0 to t1 in FIG. 3 and the duration from time t0 to t4 in FIG. 4.

At step S6, a check is made of whether the starting operation is the hot starting or the cold starting. In the case (YES) of the hot starting flag being ON (1), the starting operation is judged to be the hot starting, and step S7 is then reached. In the case (NO) of the hot starting flag being OFF (0), the starting operation is judged to be the cold starting, and step S8 is then reached.

At step S7, there is executed a processing for the case that the starting operation is a hot starting. That is, as shown as the duration from time t1 to time t2 in FIG. 3, the combustion air pump 66 is controlled to gradually increase the supply quantity of combustion air supplied from the air supply source Sa through the combustion air supply pipe 65 to the burner 20. Further, the supply quantity of combustion fuel supplied from the fuel supply source Sf through the combustion fuel supply pipe 47 to the burner 20 is held to be constant. Thus, combustion fuel is supplied sufficiently for the burner 20 not to put out the fire. In FIG. 3, symbols GT1, GF1, GA1, GW1 and GR1 represent the inner wall temperature T of the reforming section 11, the supply quantity of combustion fuel, the supply quantity of combustion air, the supply quantity of reforming water and the supply quantity of the reforming fuel, respectively. Step S9 follows the execution of step S7.

At step S8, there is executed a processing for the case that the starting operation is a cold starting. That is, as shown as the duration from time t4 to time t5 in FIG. 4, the combustion air pump 66 is controlled to gradually increase the supply quantity of combustion air supplied from the air supply source Sa through the combustion air supply pipe 65 to the burner 20. Further, the combustion fuel pump 48 is controlled to gradually decrease the supply quantity of combustion fuel which is supplied from the fuel supply source Sf through the combustion fuel supply pipe 47 to the burner 20. Thus, the combustion fuel is made to burn completely, whereby it can be realized to reduce CO and NOx in the combustion exhaust gas and to make the inner wall temperature T of the reforming section 11 rise gently. Here, by utilizing a software timer, it is possible to increase the supply quantity of combustion air gradually as well as to decrease the supply quantity of combustion fuel gradually. In FIG. 4, symbols GT2, GF2, GA2, GW2 and GR2 represent the inner wall temperature T of the reforming section 11, the supply quantity of combustion fuel, the supply quantity of combustion air, the supply quantity of reforming water and the supply quantity of the reforming fuel, respectively. Step S9 follows the execution of step S8.

At step S9, waiting is continued until the inner wall temperature T of the reforming section 11 exceeds 400° C., and step S10 is reached when the temperature T exceeds 400° C. At step S10, as shown in FIG. 3 (time t2) and FIG. 4 (time t5), the water pump 53 is driven and the water valve 54 is opened to supply reforming water at V1 cm³/min (V1=3 in this particular embodiment) from the reforming water supply source Sw through the feedwater pipe 51 to the evaporator section 12. The reforming water is heated at the evaporator section 12 to turn into steam, which is then supplied to the reforming section 11 through the steam supply pipe 52. Thus, the reforming catalyzer hardly has nonuniformity in temperature, and the quality of the fuel gas becomes easier to stabilize. Further, since the reforming section 11 is supplied with reforming water without being supplied with reforming fuel, it can be realized to prevent carbon from adhering to the reforming catalyzer. In the hot starting routine, the reforming water, when supplied, immediately turns into steam, and thus, no problem arises even if reforming fuel is supplied at the same time as supplying reforming water. Therefore, in the hot starting routine, it is possible to supply reforming fuel at step S10. Step S11 follows the execution of step S10.

At step S11, waiting is continued until the inner wall temperature T of the reforming section 11 exceeds 600° C., and step S12 is executed when the temperature T exceeds 600° C. At step S12, the reforming fuel pump 43 is driven and the second fuel valve 45 is opened to supply reforming fuel from the fuel supply source Sf through the fuel supply pipe 41 to the reforming section 11. Further, the water pump 53 is controlled to supply reforming water at V2 cm³/min (V2=8 in this particular embodiment) from the reforming water supply source Sw through the feedwater pipe 51 to the evaporator section 12. Thus, in the reforming section 11, the steam reforming reaction takes place, in which a mixture gas of reforming fuel and steam reacts through the catalyzer, whereby reforming gas is generated. The reforming gas is reduced in carbon monoxide as a result of passing through the CO shift section 13 and the CO selective oxidation section 14 and is led from the reformer 10 to the reforming gas supply pipe 71. Further, as shown in FIG. 3 (time t3) and FIG. 4 (time t6), the combustion fuel pump 48 is stopped gradually by utilizing a software timer, whereby the supply of combustion fuel from the fuel supply source Sf to the burner 20 is discontinued gradually. Thus, the combustion of the burner 20 can be maintained with the reforming gas which is supplied from the reformer 10 through the reforming gas supply pipe 71, the bypath pipe 73 and the offgas supply 72 to the burner 20. Here, steps S6 to S12 constitute a second operation stage. Further, steps S7, S9, S10, S11 and S12 cover the hot starting routine, whereas steps S8, S9, S10, S11 and S12 cover the cold starting routine.

The execution of the starting operation program is terminated after execution of step S12. Further, upon termination of the execution of the starting operation program, an ordinary operation program (not shown) begins to be executed, wherein after elapse of a predetermined time taken to make the reforming gas stable, the first reforming valve 74 and the offgas valve 75 are opened, and the second reforming gas valve 76 is closed. Further, the cathode air pump 68 is driven and the cathode air valve 69 is opened to supply cathode air from the air supply source Sa through the cathode air supply pipe 67 to the oxidizer pole 32 of the fuel cell 30. Thus, the fuel cell 30 is brought into the ordinary operation to generate electric power.

In the fuel cell starting method and the fuel cell system in the present embodiment, after the burner 20 is ignited at step S4 with combustion fuel and combustion air being supplied thereto, the ratio in supply between combustion fuel and combustion air is varied at steps S7 and S8 in dependence on the inner wall temperature T before the ignition of the reforming section 11. Specifically, where the inner wall temperature T of the reforming section 11 before the ignition is equal to or lower than 100° C., the supply of combustion fuel is decreased and the supply of combustion air is increased at step S8. Where the inner wall temperature T of the reforming section 11 before the ignition is higher than 100° C., the supply of combustion fuel is held to be constant at step S7. That is, where the inner wall temperature T of the reforming section 11 before the ignition is higher than 100° C., combustion fuel and combustion air are supplied so that the air ratio in this case becomes smaller than that in the case of being equal to or lower than 100° C. Here, the term “air ratio” means an actual air quantity to an air quantity which is needed for fuel to burn completely. Therefore, where the fuel cell is to be restarted right after being stopped, combustion fuel has been supplied sufficiently at step S7, and thus, the fire of the burner 20 is hardly put out even if reforming water turned into steam enters the burner 20 through the reforming gas supply pipe 71, the bypath pipe 73 and the offgas supply pipe 72. Further, because different sequences are used respectively at the steps S7 and S8, the range of a tolerable air ratio for keeping the combustion can be made to be wide. Accordingly, in the fuel cell starting method and the fuel cell system, it can be realized to start the fuel cell stably.

Although the fuel cell starting method and the fuel cell system according to the present invention has been described based on the embodiment, it is needless to say that the present invention is not limited to the embodiment and may be practiced in any other form which is suitably modified not to contradict with the technical concept of the present invention.

### INDUSTRIAL APPLICABILITY

The fuel cell starting method and the fuel cell system according to the present invention is able to widen a tolerable air ratio for keeping the combustion and hence, is suitable for starting a fuel cell stably.

1-8. (canceled)

9. A fuel cell starting method for a system including a reformer for generating fuel gas containing hydrogen from reforming fuel and reforming water, a burner for heating the reformer, and a fuel cell for generating electric power from the fuel gas and oxidizer gas, the method comprising:
a first operation stage of igniting the burner with combustion fuel and combustion air being supplied thereto; and
a second operation stage of continuously supplying the combustion fuel and the combustion air to the burner and of supplying the reforming water to the reformer, wherein at the second operation stage, gas led from the reformer is led to the burner,
wherein the second operation stage includes:
a cold starting routine for a case that the temperature of the burner before ignition is equal to or lower than a predetermined temperature, and
a hot starting routine for supplying the combustion fuel and the combustion air to make the air ratio in the hot starting routine smaller than that in the cold starting routine in a case that the temperature of the burner before ignition is higher than the predetermined temperature.

10. The fuel cell starting method as set forth claim 9, wherein the cold starting routine is decreased in the supply of the combustion fuel than the first operation stage and is increased in the supply of the combustion air than the first operation stage.

11. The fuel cell starting method as set forth claim 9, wherein the reformer is supplied at the second operation stage with the reforming water without being supplied with the reforming fuel.

12. The fuel cell starting method as set forth claim 10, wherein the reformer is supplied at the second operation stage with the reforming water without being supplied with the reforming fuel.

13. The fuel cell starting method as set forth claim 9, wherein the supply of the combustion fuel in the hot starting routine is held at a predetermined flow rate.

14. The fuel cell starting method as set forth claim 10, wherein the supply of the combustion fuel in the hot starting routine is held at a predetermined flow rate.

15. The fuel cell starting method as set forth claim 11, wherein the supply of the combustion fuel in the hot starting routine is held at a predetermined flow rate.

16. A fuel cell system comprising:
a reformer for generating fuel gas containing hydrogen from reforming fuel and reforming water;
a burner for heating the reformer;
a fuel cell for generating electric power from the fuel gas and oxidizer gas; and
control means for performing a first operation stage of igniting the burner with combustion fuel and combustion air being supplied thereto and a second operation stage of continuously supplying the combustion fuel and the combustion air to the burner and of supplying the reforming water to the reformer, wherein at the second operation stage, the control means leads gas led from the reformer to the burner,
wherein at the second operation stage, the control means executes:
a cold starting routine for a case that the temperature of the burner before ignition is equal to or lower than a predetermined temperature, and
a hot starting routine for supplying the combustion fuel and the combustion air to make the air ratio in the hot starting routine smaller than that in the cold starting routine in a case that the temperature of the burner before ignition is higher than the predetermined temperature.

17. The fuel cell system as set forth in claim 16, wherein the cold starting routine is decreased in the supply of the combustion fuel than the first operation stage and is increased in the supply of the combustion air than the first operation stage.

18. The fuel cell system as set forth in claim 16, wherein the reformer is supplied at the second operation stage with the reforming water without being supplied with the reforming fuel.

19. The fuel cell system as set forth in claim 17, wherein the reformer is supplied at the second operation stage with the reforming water without being supplied with the reforming fuel.

20. The fuel cell system as set forth in claim 16, wherein the supply of the combustion fuel in the hot starting routine is held at a predetermined flow rate.

21. The fuel cell system as set forth in claim 17, wherein the supply of the combustion fuel in the hot starting routine is held at a predetermined flow rate.

22. The fuel cell system as set forth in claim 18, wherein the supply of the combustion fuel in the hot starting routine is held at a predetermined flow rate.
